(19) United States
(12) Patent Application Publication
(10) Pub. No.: US 2005/0027596 A1
(43) Pub. Date: Feb. 3, 2005

(54) Internet marketing system using a foreign object search in the form of an interactive game

(75) Inventors: Carl A. Bender, Charlottesville, VA (US); Richard Zimmer, Charlottesville, VA (US); Matthew Mueller, Charlottesville, VA (US); Christian M. Rowan, Charlottesville, VA (US)

Correspondence Address: NIXON & VANDERHYE, PC, 1100 N GLEBE ROAD, 8TH FLOOR, ARLINGTON, VA, 22201-4714, US

(73) Assignee: Worm, Inc., Charlottesville, VA (US)

(21) Appl. No.: 10/864,862

(22) Filed: Jun. 10, 2004

Related U.S. Application Data
(63) Continuation of application No. 09/504,892, filed on Feb. 16, 2000.

(51) Int. Cl. G06F 17/60

(52) U.S. Cl. 705/14

(57) ABSTRACT

A system and method for directing consumer traffic over the Internet properties of affiliated content providers and vendors increases traffic over affiliated sites by embedding a foreign object within those properties, and encouraging consumers to search for that object. Consumers register with the marketing solutions provider in order to become eligible to participate in the object search game. Content providers and vendors also register in order to become part of the said system that directs consumers to various Internet properties. Such an affiliate has their account credited once a consumer has been successfully directed to that affiliated property. The consumer has his or her account credited after successfully finding the object resident on that affiliate's property. Furthermore, in the case of vendors, should a consumer led to that affiliate's Internet property seek to make a purchase while there, relevant information concerning that consumer can be sent directly from the marketing solutions provider to the vendor, making the sales process more convenient for both the vendor and the consumer.

### CROSS-REFERENCES TO RELATED APPLICATIONS

This application is a continuation of application Ser. No. 09/504,892, filed Feb. 16, 2000, incorporated herein by reference.

### FIELD OF THE INVENTION

The present invention relates to systems of electronic commerce and entertainment on the Internet, and more particularly to systems and methods for increasing exposure of affiliates' merchandise and content.

### BACKGROUND OF THE INVENTION

The past several years have been characterized by explosive technological growth and innovation, but perhaps no technology promises to change the lives of consumers more than that of the Internet. The Internet is the medium over which interactive devices can communicate and relay information to one another. These interactive devices include, but are not limited to, personal computers, interactive televisions, Internet capable phones, and personal digital assistants (PDAs).

The most popular and widely used aspect of the Internet is the World Wide Web. Over the World Wide Web, often referred to as the “Web”, a user may access “websites.” Websites are computers that provide code written in one of a number of computer programming languages that once opened by a “web browser,” display text and graphical images on the user's screen or monitor determined by the code. The web browser software resides on the user's Internet capable appliance, with examples of such software being the popular web browsers by Netscape and Microsoft made for personal computers. The website itself is hosted on either the site creator's computer or on a remote server, the latter being a computer built with the express purpose of hosting such sites for speedy and reliable access over the Web. The majority of commercial sites are hosted on these servers.

Due to its rising popularity and increasing penetration, companies have begun to recognize the Web as a valuable medium over which goods and services can be sold. Many such companies have already established a presence on the Web in the form of a website. In order to draw attention and traffic to their sites, a number of these companies have initiated Internet marketing campaigns in an effort to increase awareness among the Internet-capable portion of the population. Unfortunately, while the Internet promises great efficiency from a commercial standpoint, advertising thus far on the Internet has been very inefficient. This is due mainly to the fact that there does not exist a mechanism for effectively routing consumer traffic to the content on an advertiser or affiliate's website.

Current Internet marketing consists of “banner advertisements” and methods of motivating Internet users to visit specific sites on the World Wide Web in exchange for various rewards. Banner advertisements are the typical mode of advertising on the World Wide Web, most often taking the form of rectangular spaces on a website, containing whatever text or images an advertiser chooses to place within them. Once “clicked” on by the user, the banner ad takes the user directly from the website that the user is currently browsing to that of the advertiser. See, for example, U.S. Pat. No. 5,948,061.

Though banner advertisements are a fast and easy advertising solution, their major downfall lies in the fact that the user usually has no interest in, or reason, to click on those ads. It has also become a problem for Internet advertising that many consumers have begun to resent the banner ads that clutter the Web. The result is that banner ads draw only a minimal number of consumers to an advertiser's site.

In an attempt to answer the problems associated with banner ads, a number of advertisers have adopted reward systems to motivate consumers to visit affiliated websites. These systems function by rewarding the user for visiting an affiliate site; with the rewards for doing so including points applicable towards free/reduced price merchandise or direct cash incentives. While such systems tend to draw consumers to the target sites, the trend is for those consumers to leave as soon as they arrive, greatly undermining the marketing value of these systems. This is because the points or cash are acquired as soon as the user's browser opens the target site, and following that, there ceases to be any incentive for the consumer to be there. As a result, this system has not ended, but perpetuated the squandering of advertising dollars.

Software programmers have in the past been known to hide objects such as graphics within a software user interface. Such hidden objects are sometimes called “Easter Eggs”. If the user finds and clicks on the “Easter Egg”, he or she may be rewarded by, for example, being presented with a “secret” message, an animation, a sound or a game play hint. Easter Eggs have been used in the past primarily for non-commercial, entertainment value, but it appears that some have, in the past, hid “Easter Eggs” in web pages for more commercial purposes such as encouraging consumers to visit online “store fronts” as part of one-time contests of short duration. However, it does not appear that anyone in the past has found a successful, practical system and method for using such techniques systematically over the long term to attract consumers to advertisers' and affiliates' websites.

Thus far, a cost-effective way of attracting consumers to advertisers' and affiliates' websites and having them browse through the content of those sites has failed to emerge.

Another problem commonly encountered by web users relates to the need to constantly fill in website forms with the same information. For example, when a consumer wants to purchase goods or services from a first web provider, the consumer typically needs to register with that web provider by filling in a form containing the user's name, address, telephone number, and other identifying information. If the consumer visits a second web site and wants to purchase goods from the second web site, the consumer will typically need to fill in the same information into a form at the second web site. Browser developers have tried to address this duplicative data entry problem by developing smart browser features that recognize form the browser has encountered before and allowing giving the user the option of allowing the browser to fill the form automatically with the same information the user supplied previously to fill in the form. Such functionality is provided, for example, as part of Internet Explorer 5.0 distributed by Microsoft. However, this solution works only with forms the browser has previously encountered—even though each online merchant typically uses a different form. Therefore, a need exists to reduce the amount of duplicative information a consumer must enter when shopping the web.

### SUMMARY OF THE INVENTION

The present invention addresses these and other problems with Internet marketing discussed above by providing a Web-based mechanism to draw consumers to an affiliate's website in a manner which would discourage those consumers from leaving the website shortly after their arrival. In particular, the system embeds a foreign object on an affiliate's site that users of interactive devices are then encouraged to go look for by browsing through the affiliate's site in search of that object. The interactive devices this system can be used with include, but are not limited to, personal computers, interactive televisions, Internet capable phones, personal digital assistants (PDAs), and other web-capable appliances. The preferred embodiment includes a tracking and coordination system that tracks the consumer's activities across a number of different affiliate and advertiser web sites, and stores such information in a database.

One preferred embodiment provided by the invention is presented in the form of an interactive game, in which the user is encouraged to browse through an affiliate's site in search of a foreign object embedded within that site. To function, the preferred embodiment includes a communications system made up of three separate entities, including: a content provider, a marketing solutions provider, and a consumer. Preferably, the consumer begins by visiting the marketing solution provider's website, where that user has an account. From there, the user travels to affiliated sites using the links located on the marketing solution provider's website. These links lead the user directly to websites participating in the program, where upon arrival, the user searches that site for the foreign object embedded within. Since the foreign object may be hidden anywhere on the web site, the user may need to search through and view several or many pages of the site to find the object. In this way, one aspect of the present invention is to provide some of the excitement and interest of an Easter Egg or scavenger hunt in cyberspace—but with an overall goal of enticing or encouraging the consumer to look at the affiliate's content posted on its web site, and with a result that coordinates several different web sites and builds brand loyalty.

Upon finding the object, an electronic message is sent to the marketing solution provider's website. The site then interprets the message and the user's account is credited with a successful “find.” The results for finding the embedded object might vary depending on the needs of affiliates, or on the resources available to the marketing solutions provider, but they would generally translate into some form of point-based reward. These points may be applicable towards free or discounted merchandise on, or through, the marketing solution provider's home site. In this way, the marketing solutions provider creates for its affiliates a system with sufficient consumer appeal to not only draw consumers to an affiliate site, but also to have those consumers browse through the content of said affiliate's site. Furthermore, in one embodiment the foreign object is quite distinctive (e.g., a cartoon character or immediately recognizable item that consumers can immediately associate with a particular marketing solution provider)—enabling the marketing solution provider to develop consumer and affiliate brand loyalty through distribution of the foreign object on the web sites of many affiliates and/or advertisers.

Should the object embedded on an affiliate's site be found by a registered user while not logged into the marketing solutions provider's website, an electronic message will be sent to the marketing solutions provider. Upon being interpreted, the website will proceed to pull information off a file resident on the user's computer. This file contains the information concerning that user's account, and that user will be redirected to the marketing solutions provider's website in order to login. Once the user is logged in, they will be able to gain credit for finding the embedded object. Should a non-registered user find the object, the marketing solutions provider will be unable to locate the necessary file on the user's computer. In this case, the hidden object functions in the same way a typical banner ad would, by taking the non-registered user directly to the marketing solution provider's website.

If a consumer wishes to become a registered user, they must set up an account with the marketing solutions provider on their home website. The account is set up by entering basic, but pertinent demographic information, which is stored on a database. The user is then assigned an account name of his/her own choosing. By referencing the database, would-be affiliates and partners alike are able to get a feel for the demographic breakdown of the user base associated with the marketing solutions provider's website, and thus are better able to utilize their marketing dollars. Alternatively, the marketing solutions provider could choose to customize each member's game experience so that primarily affiliates' sites with direct appeal to that particular consumer would be highlighted at the game's start. In this way, users in search of the embedded object would be directed to sites that would appeal to their specific interests.

In order to have users trafficked to them, content providers may also create accounts with the marketing solutions provider. Upon registering as an affiliate, an account is created for the content provider, containing along with pertinent information, a feature that allows the affiliate to track the number of users directed to the affiliates' site via the embedded object gaming system. The affiliate and the marketing solutions provider then jointly determine where the hidden objects will be placed on the affiliate's site, and how often their site will be featured by the game. In addition, should a consumer seek to make a purchase on an affiliated site while logged into the game, it would be possible for the marketing solutions provider to automatically send any information relevant in the sales process directly to the affiliate.

For example, to help solve the problem of duplicate data entry, the preferred embodiment has a capability of providing certain basic identifying information from the marketing provider's database to assist the consumer in filling out forms provided by online merchants, affiliates and/or advertisers. In one example arrangement, the marketing provider provides such information to the user's browser without allowing the affiliate web site to capture it unless the consumer authorizes the capture. For example, the marketing provider's web site may send the consumer's browser a partially completed form, or it may send consumer identifying information to an affiliate's site for use in completing a form but subject to an agreement that the affiliate cannot capture the information without the user taking further action. The affiliate's web site receives the identifying information only if the consumer chooses to send the completed form to the affiliate web site (e.g., as part of an online purchasing transaction). In this manner, the sales process becomes more convenient for both the affiliate and the consumer, as the tedious task of entering user information is much expedited. This would also ensure a higher degree of closed sales for the affiliate, as simply the task of entering large amounts of information is frequently enough to make a consumer change his/her mind about completing a purchase.

Fees charged to the registered content providers by the marketing solutions provider may take several forms, with two in particular being especially suited to the task. First, one system would use the same traffic-related file stored on the affiliate's account to determine a fee based on the number of users directed to that affiliate's site. Otherwise, if the affiliate in question were a vendor or service provider of some sort, a system could be set up which would give the marketing solutions provider a commission for all merchandise or services purchased by a consumer who was sent to that site via the object search system. The affiliate in question and the marketing solutions provider would determine the rate of the commission jointly.

By employing the system of the present invention, it becomes possible for affiliated content providers and vendors to greatly increase the efficiency of their marketing spending. This would permit the aforementioned affiliates to reduce the amount spent on advertising and marketing, thereby freeing up funds for reinvestment in other areas. In addition, vendors and service providers seeking to offer increasingly competitive consumer pricing would benefit, as a smaller portion of revenues would be diverted to marketing.

### BRIEF DESCRIPTION OF THE FIGURES

These and other features and advantages of the invention may be better and more completely understood by referring to the following description of presently preferred example embodiments in conjunction with the drawings, of which:

FIG. 1 is a high-level block diagram illustrating the preferred embodiment of the present invention in a communications system in which a consumer browser device, marketing solutions provider, and affiliate can interact with one another.

FIGS. 2A and 2B are block diagrams depicting the preferred scenarios for a consumer to initiate the embedded object search game.

FIG. 3 is an example of a typical Internet website as seen on a consumer's browser, and shows how an embedded object would appear on such a site.

FIG. 4 is a flow chart illustrating the preferred process for crediting accounts and updating databases once the embedded object is found.

FIG. 5 is a block diagram showing the flow of information in respect to the user's browser device, the affiliate, and the marketing solutions provider once the embedded object is found.

FIG. 6 is a flow chart illustrating the manner by which the system of the present invention may aid in the purchase of goods or services online.

FIG. 7 is a combination flow chart/block diagram depicting the method by which a consumer registers with the marketing solutions provider.

FIG. 8 is an example of a typical registration form as seen on the Web.

### DETAILED DESCRIPTION OF PREFERRED EMBODIMENTS

The present invention provides a mechanism for drawing consumer traffic to an affiliated site in an efficient and cost-effective manner. In an example preferred embodiment, an object is embedded within an affiliate's website, and consumers are encouraged to search for that object by means of an interactive game provided by a marketing solutions provider. Although the present invention is described below in terms of a preferred interactive communications system, the invention is not limited to that system, and it is applicable to any situation in which it would be advantageous to increase consumer traffic over an interactive medium.

To aid in the understanding of the present invention, the remainder of the detailed description is arranged within the following sections:
I. Overview of the Preferred Interactive Communications System
II. Implementation of the Preferred Embodiment of the Present Invention
III. Method of Registration
IV. Conclusion
   I. Overview of the Preferred Interactive Communications System

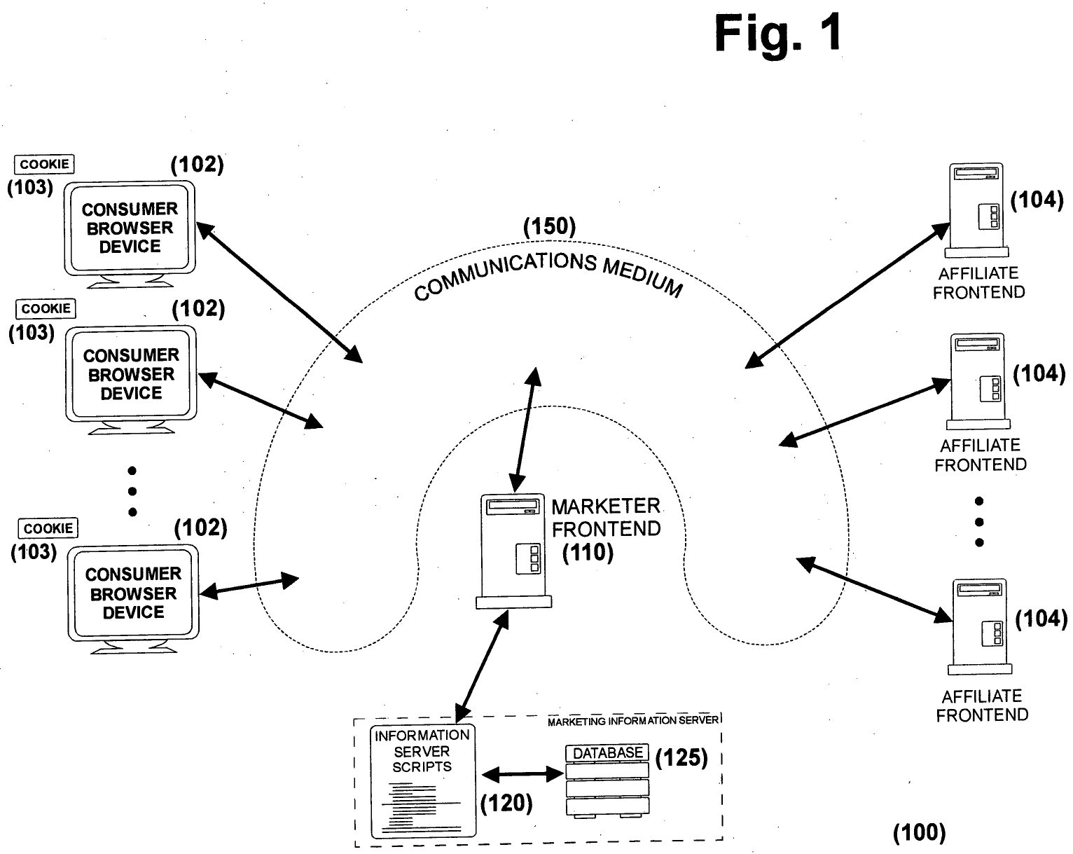

The preferred embodiment of the present invention is implemented within an interactive communications system. FIG. 1 illustrates the preferred interactive communications system and the individual parts of which it is comprised. The interactive communications system 100 includes consumer browser devices 102, affiliated Internet properties 104, and a marketing solutions provider 110. In the preferred embodiment, these separate entities communicate with one another through a communication medium known as the “World Wide Web.” In FIG. 1, the World Wide Web, or “Web” for short, is depicted as item 150.

In practice, a consumer, using a consumer browser device 102, may access the Internet properties of affiliates 104 or of the marketing solutions provider 110 through means of the communications medium 150. Information available to the consumer on these properties, known on the Web as “websites,” is displayed visually on the consumer browser device 102 in the form of a “page.” These WebPages are encoded using a programming language known as Hyper Text Markup Language, or HTML for short. The interactive communications medium 100 also allows for certain files located on the consumer browser device 102 to be read and interpreted by the marketing solutions provider 110. These files contain information concerning either a consumer's account or login status with the marketing solutions provider, and are known by anyone familiar in the art as “cookies” 103.

By reading the cookies located on a consumer browser device 102, it becomes possible for the marketing solutions provider 110 to correctly and accurately credit a specific user's account. This information is stored and updated within the marketing solutions provider's information server database 125.

II. Implementation of the Preferred Embodiment of the Present Invention

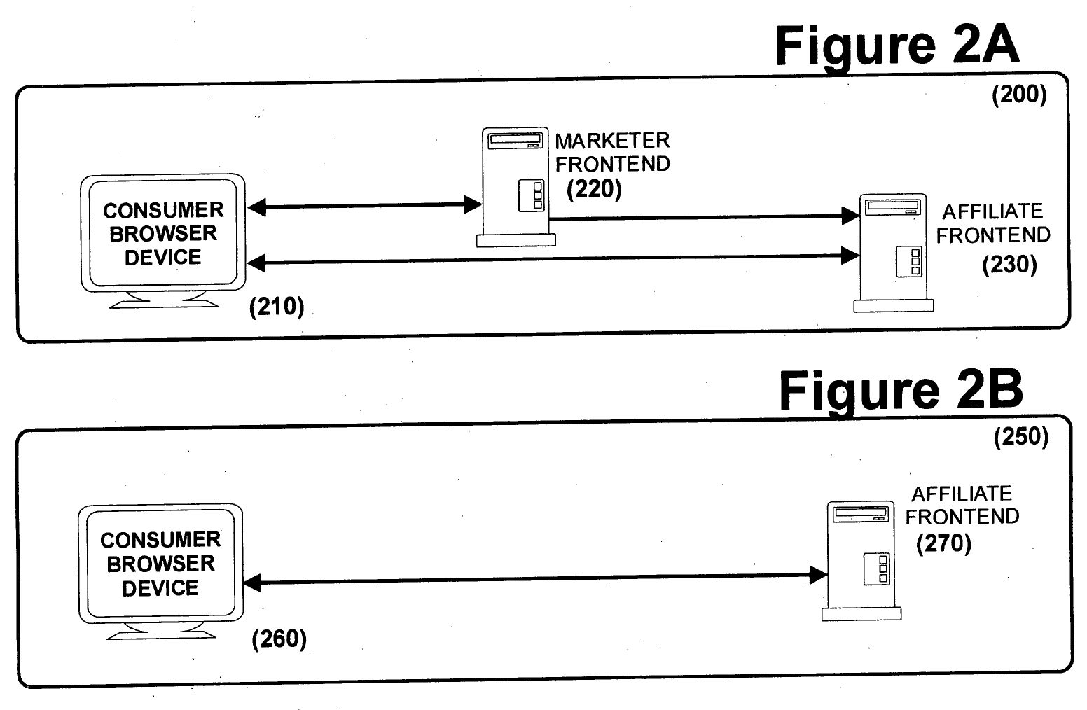

As stated in the above section, the preferred embodiment of the present invention is employed in an interactive communications system, the preferred of which is depicted in FIG. 1. Within such a system, a consumer has two methods readily available to him/her with which to begin the embedded object search game. A block diagram illustrating both of these scenarios is found in FIGS. 2A and 2B.

In scenario 1 (FIG. 2A), a consumer using a browser device 210 visits the website of the marketing solutions provider 220, with whom that consumer has an account. While on the site, the consumer will have the option of logging in and commencing the embedded object search game. Should the consumer choose to login, a new page will be presented to the consumer browser device 210 containing a link(s) leading to an affiliated web site(s) 230. Upon visiting the affiliated site 230, a new “window” will open on the consumer browser device 210, containing the WebPages encoded within that site. Within the aforementioned pages will lay the embedded object that the consumer seeks to find.

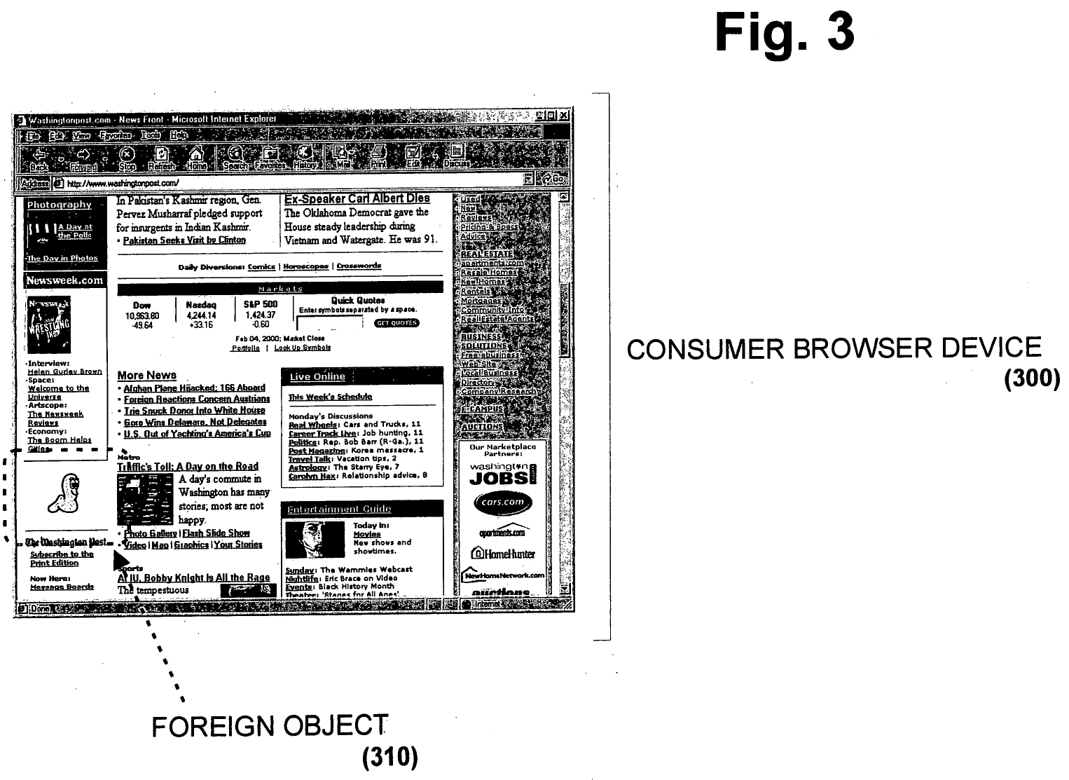

FIG. 3 demonstrates the appearance of a typical example website over the screen of a consumer browser device 300. Also shown is an example of a foreign object 310 embedded within that site—in this particular example, a graphical image of a worm character. Foreign object 310 may include any distinctive graphical, audible, multimedia or other object capable of being presented by the user's browser device 300. It would be the goal of the consumer visiting the affiliate site 230 to locate the foreign object 310 by use of a consumer browser device 300.

Referring back to FIG. 2A, scenario 1 is not the only means by which a consumer may initiate the embedded object search game. Scenario 2 shown in FIG. 2B demonstrates an alternative method. In this scenario, a consumer browser device 260 connects to an affiliated site 270 containing an embedded object placed by the marketing solutions provider (not shown). The layout of the affiliate website in scenario 2 (FIG. 2B) is identical to the layout of the page in scenario 1 (FIG. 2A), depicted by the consumer browser device 300 in FIG. 3. The location and appearance of foreign object 310 would also appear identical, regardless of the method used in reaching it.

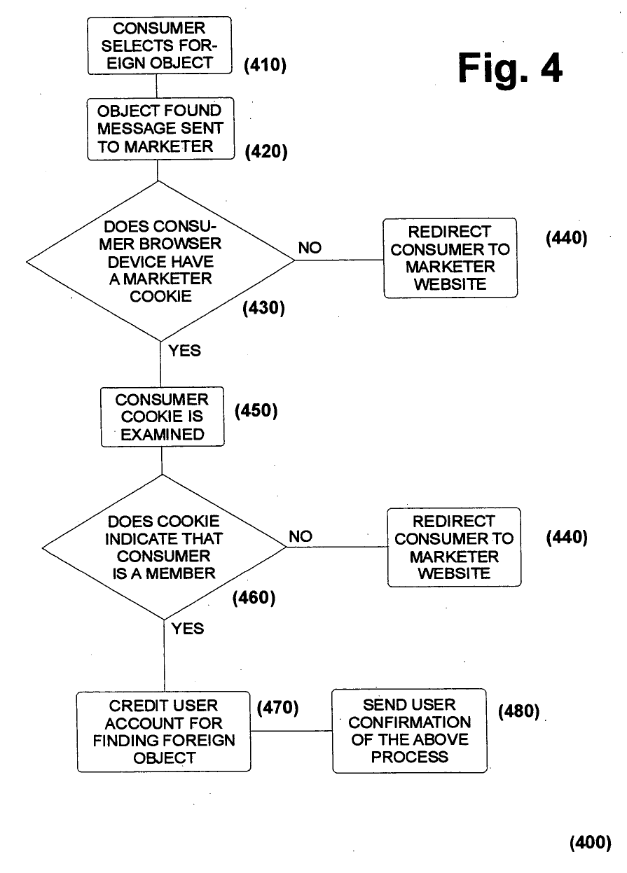

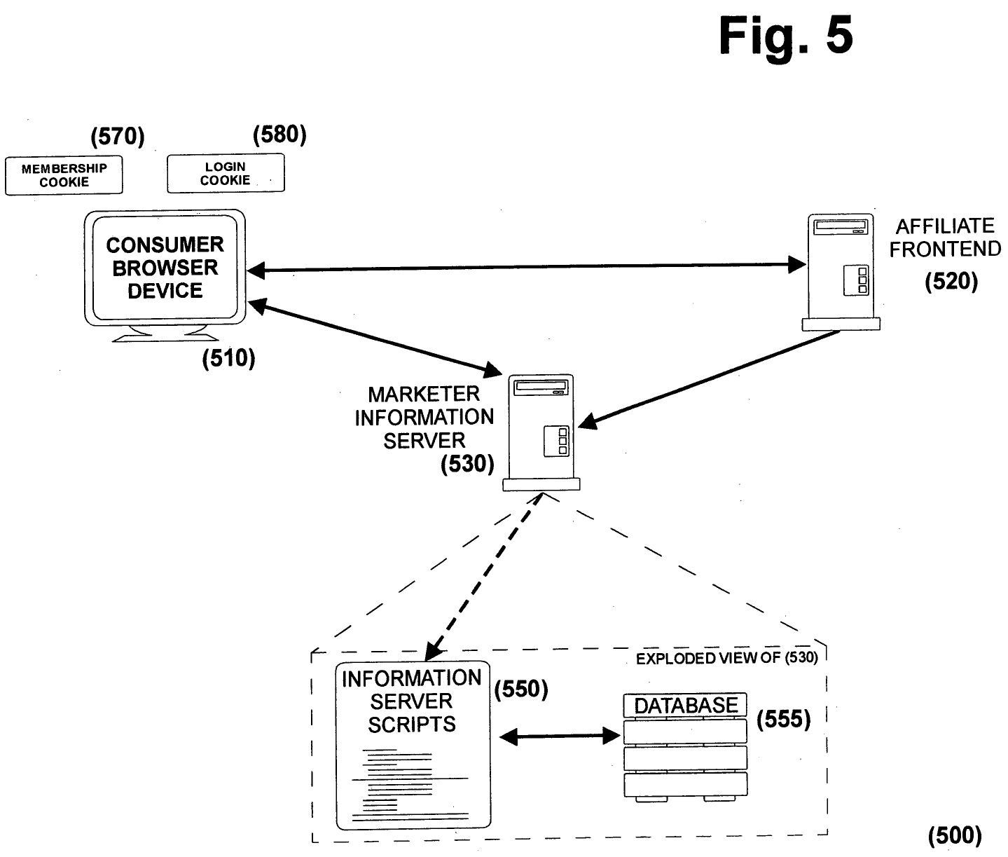

FIG. 4 is a flow chart illustrating the chain of events occurring once the consumer has located the embedded object within an affiliated site. FIG. 5 is a block diagram complementing FIG. 4 and showing the flow of information across the interactive communications system once the embedded object is located. Referring to FIG. 4, having selected 410 the foreign object, an electronic message is sent 420 from the affiliate site to the marketing solutions provider. In FIG. 5 this is demonstrated by the flow of information from the affiliated website 520 to the marketing solutions provider site 530. Upon receiving this message, the marketing solutions provider searches the consumer browser device for a cookie 570 containing information stating that the consumer is a registered member. This process is represented in FIG. 4 by event 430. The marketing solutions provider deposits such a cookie on each registered consumer's web browsing device upon registration. If the cookie is not found 440, then the consumer will be redirected to the marketing solutions provider's website. This redirection might take several forms, including but not limited to: the opening of a smaller window on the consumer browser device leading to the marketing solutions provider website, or a direct link to the marketing solutions provider website in a manner similar to a banner ad.

Referring again to FIG. 5, the flow of information between the consumer browser device 510 and the marketing solutions provider 530 is delineated. As stated above, having received the prompt that the embedded object has been found, the marketing solutions provider 530 initiates a search of consumer browser device 510 for the cookie containing basic membership information. Upon finding said cookie, a trigger is activated redirecting the marketing solutions provider 530 to search for a second cookie 580 on consumer browser device 510. This cookie contains information relating to the login status of the consumer. FIG. 4 demonstrates this in action 460. If the user is found to not be logged in, the consumer browser device 510 is sent an electronic message redirecting the user to the marketing solutions provider's website 530 in a manner similar to the event 440 described above and illustrated in FIG. 4. In this way, the user is given the opportunity to login. If the cookie on the consumer browser device 510 is found to contain login information, information server scripts 550 then interpret the information located on that cookie file to determine which member account is to be credited. The consumer account resident on the marketer's database 555 is subsequently updated, and a confirmation message is sent to the consumer. Once received, this message is displayed on consumer browser device 510. Also updated on the marketing solutions provider's database 555 are accounts and records concerning total number of embedded objects found on that affiliate's site and trends relating to consumer demographic behavior in playing the embedded object search game, useful for either research or marketing purposes. The crediting of the consumer's account and the corresponding confirmation sent to that user are depicted in FIG. 4 as items 470 and 480 respectively.

The preferred embodiment of the present invention also facilitates the purchasing of goods or services for both consumers and affiliated content providers/vendors. Should the marketing solutions provider and an affiliate reach an agreement to do so, any consumer purchasing some good or service on that affiliated site while logged into the embedded object search game would find the process much expedited.

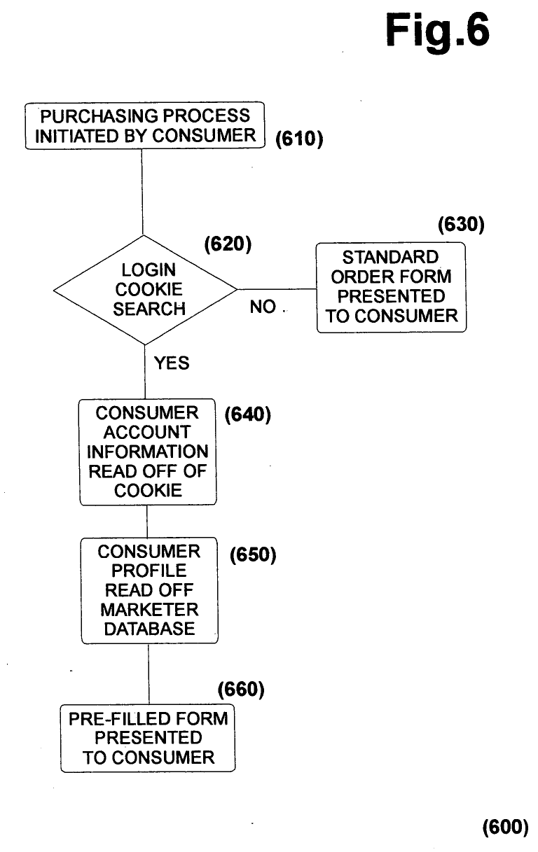

FIG. 6 demonstrates the process by which basic fields of information used in most purchases on the Web would be filled by the marketing solutions provider as opposed to the consumer themselves, saving both the consumer and affiliate time. Once a user has initiated purchasing process 610, the affiliated site runs a search 620 of the consumer browser device in order to determine whether the consumer has a login cookie originating from the marketing solutions provider's website. Should the search 620 fail to locate the login cookie, the affiliate will present 630 the standard order form to the user. This form will be empty and must be filled out by the user in the normal manner. Should a cookie be located on the consumer browser device, the sales process will proceed to event 640. Using a script to identify the consumer account name located on the login cookie, the affiliate will send an electronic message to the information server of the marketing solutions provider. This message will request basic consumer information relating to the current sale on the affiliated site. After having received this information request, the marketing solutions provider server will credit an account, which keeps track of sales generated while consumers are logged in. The information requested by the affiliated site is then sent to that site, where a script interprets 650 it. Once interpreted, a form will be presented 660 to the consumer similar to the form presented in event 630, except that basic fields will already be filled, using the information read off the marketing solutions provider's database. Possible examples of such fields include, but are not limited to: user name, user home address, user mailing address, user e-mail address, and a work/home telephone number. This information would be on display as normal on the form, and the user would have the option to change any of the information should he or she wish to.

III. Method of Registration

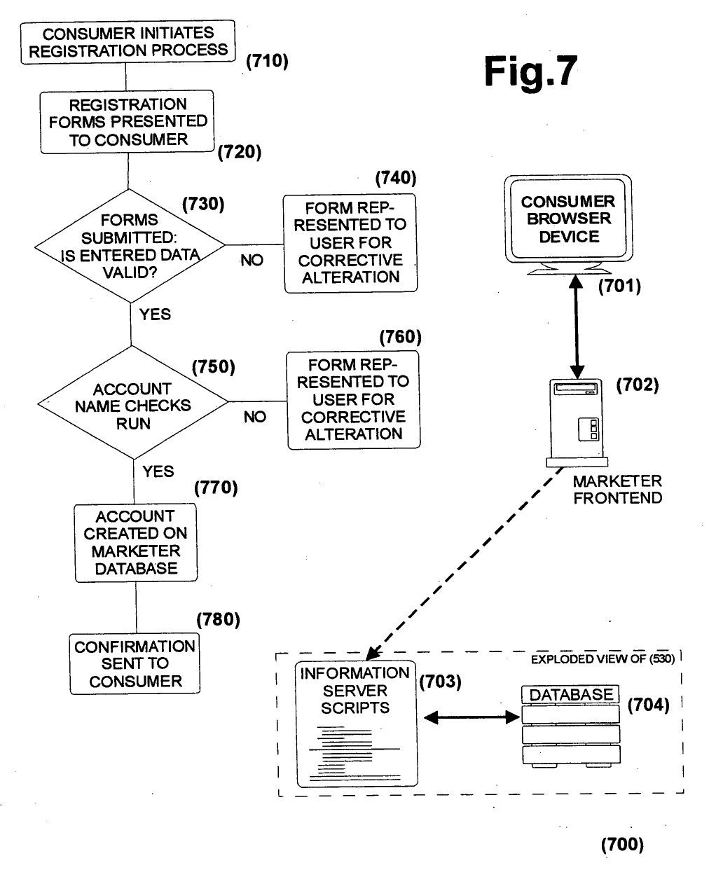

In the preferred embodiment of the present invention, before becoming eligible to play the embedded object search game, a user must register with the marketing solutions provider. FIG. 7 contains both a flow chart and a block diagram, outlining the process by which a consumer registers with the marketing solutions provider.

To begin, a consumer must have access to an interactive browser device 701. Using the browser device 701, the consumer travels via means of the Internet to the marketing solutions provider's website 702. Not being a member, once at the marketing solutions provider's site 702 the consumer will have the option of registering with the marketing solutions provider.

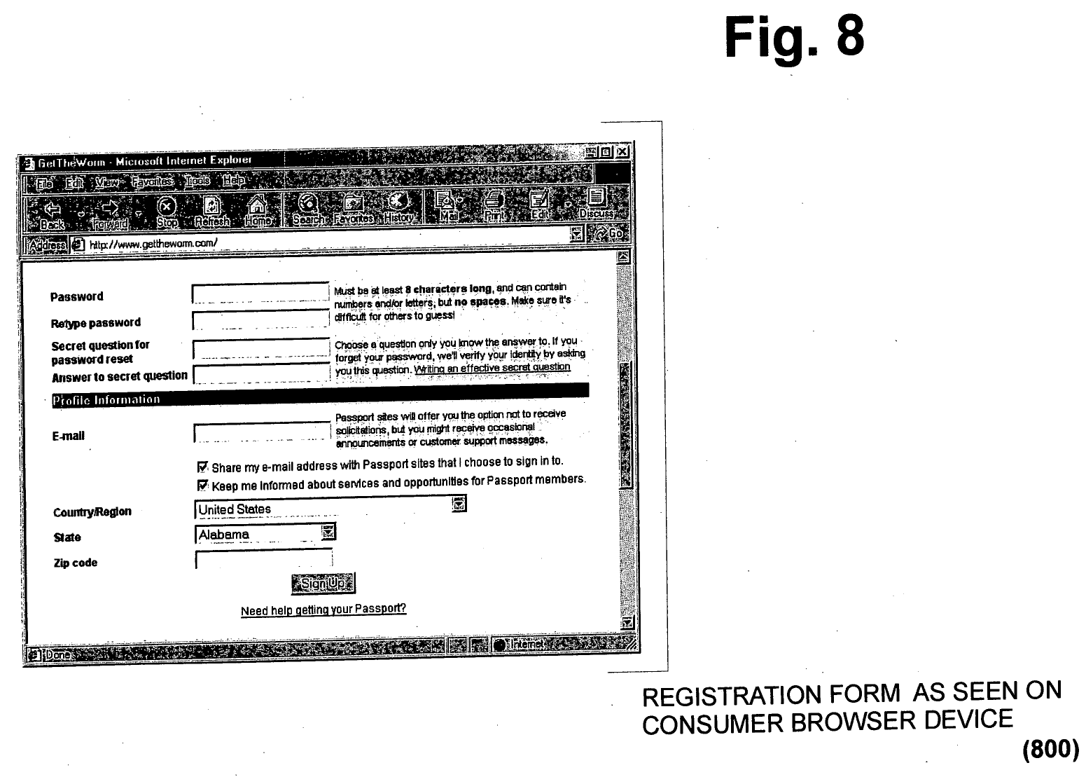

If the consumer chooses to register 710 with the marketing solutions provider, they are presented 720 with a form containing several fields into which the user is asked to enter basic information. The information entered may be used for statistical and/or marketing purposes, as well as having the possibility to determine the affiliate sites highlighted to the consumer when playing the embedded object search game. The personal interests marked off by the consumer when registering with the marketing solutions provider would be used to determine which sites were highlighted. FIG. 8 shows an example of what a registration form might look like for a consumer. Among other things, the user would be asked to enter a name under which to put the account, and a password with which to access it. The name chosen for the account would also become the login name for playing the embedded object search game, while the password for the game would be the same as the member's account password.

Upon electronic submittal of the registration form by the consumer, the marketing solutions provider runs a field-check 730 in order to determine whether all requisite fields were filled properly. If any information is missing or improperly entered, the form is sent back 740 to the consumer with an explanation as to the problem. Upon completion of a successful field-check 730, a second check 750 is performed to ensure that the account name chosen by the consumer does not conflict with an account name already in existence on the marketing solutions provider's database 704. Should the account name chosen by the consumer duplicate an account name already in existence, the form would be returned 760 to the consumer with a message that a new account name must be chosen. Otherwise, should the account name chosen be unique, a new account containing all the submitted user information will be created 770 on the information solutions provider's database 704. The newly created account will be accessible to the consumer via means of visiting the marketing solution provider's website and logging in. In addition, the consumer is now eligible to play the embedded object search game.

IV. Conclusion

While the present invention has been described above in terms of a preferred embodiment, this embodiment has been presented as an example only and has not been meant to limit the scope of the present invention. The present invention is applicable to any situation in which content providers/vendors would seek to increase visitor traffic and in which an interactive communications system exists. Thus, the scope of the present invention should be defined only in accordance with the claims and their equivalents.

1. A method of tracking consumer activity on a decentralized digital network comprising plural disparately located nodes each providing an associated interface, the method comprising:
(a) embedding distinctive foreign visual objects within interfaces provided by the plural network nodes;
(b) challenging a consumer to locate said embedded distinctive foreign visual objects by visiting the plural network node interfaces with a browsing device coupled to the network;
(c) tracking visitation path by the consumer, from the originating node throughout the plural decentralized nodes, of said embedded visual objects via digital messaging exchanged over the digital network, if and only if the embedded object is located and selected by consumer after visiting a decentralized node;
(d) recording information developed by said tracking step in a consumer profile database; and
(e) requesting compensation from the plural network nodes for each said visitation by the consumer.

2. The method of claim 1 further including registering the consumer over the digital network by requesting demographic information from the consumer for insertion into the database.

3. The method of claim 1 further including posting links to said plural network nodes on a marketing solutions provider website, with said links displayed in order according to the expressed interests and demographics of the consumer and/or criteria to be determined by the marketer, and presented to the consumer in the context of a game, leading the consumer to the plural network nodes by encouraging the consumer to exercise the links.

4. The method of claim 1 wherein the tracking step includes transmitting a message from the plural network nodes to said database in response to indication that the consumer has located the embedded objects on a node located on the decentralized digital network, if and only if consumer has exercised said link leading to that node from a marketing solutions provider website.

5. The method of claim 1 wherein the tracking step further comprises sensing, with said plural network nodes, whether the consumer selects the embedded objects to thereby indicate that the consumer has found the embedded objects.

6. The method of claim 1 further including giving the consumer an award based at least in part on the tracking step.

7. The method of claim 1 wherein the embedded foreign visual objects provide a designation of origin.

8. The method of claim 1 further including transmitting information from the consumer profile database to a selected network node visited by the consumer.

9. The method of claim 8 further including inserting the transmitted information into a form to thereby assist the consumer in conducting a transaction on the selected network node.

10. The method of claim 8 including conditioning said transmitting step on authorization by the consumer.

11. A system for tracking consumer activity on a decentralized digital network comprising plural disparately located nodes each providing an associated interface in which a distinctive foreign object has been hidden, the consumer using a browsing appliance coupled to the network to visit the plural network nodes, the system comprising:
a message receiver coupled to the network, said message receiver receiving messages over the network from any of the plural nodes indicating that the consumer has visited the node and located a distinctive foreign object hidden therein;
a database coupled to the message receiver, the database tracking which of the hidden objects the consumer has located; and
a reward arrangement that rewards the consumer based on the database contents

12. The system of claim 1 further including a registration arrangement coupled to the network the registration arrangement registering the consumer over the digital network by requesting demographic information from the consumer and inserting the requested information into the database.

13. The system of claim 1 further including a marketing solutions provider website coupled to the network, the website posting links to said plural network nodes that lead the consumer to the plural network nodes.

14. The system of claim 1 wherein the message receiver receives messages from the plural network nodes in response to indication that the consumer has located selected the embedded objects at the plural nodes, to thereby indicate that the consumer has found the embedded objects.

15. The method of claim 1 wherein it may be determined whether said embedded object shall appear as normal or shall remain as invisible and non-interactive to consumers not actively engaged in a search for said embedded objects as indicated by transmission of information stored on consumer's browsing appliance.
